(19) United States
(12) Patent Application Publication
(10) Pub. No.: US 2025/0370969 A1
(43) Pub. Date: Dec. 4, 2025

(54) METHODS, SYSTEMS, AND APPARATUSES FOR IMPROVED DEDUPLICATION PIPELINES

(71) Applicant: QlikTech International AB, Lund (SE)

(72) Inventors: Anis Najar, Paris (FR); Adekunle Ajayi, Lyon (FR); Sebastiao Correia, Paris (FR); Sizhao Lui, Paris (FR); Pedro Fillastre, Paris (FR)

(21) Appl. No.: 19/225,755

(22) Filed: Jun. 2, 2025

Related U.S. Application Data
(60) Provisional application No. 63/655,228, filed on Jun. 3, 2024.

(51) Int. Cl. G06F 16/215; G06F 16/28; G06F 40/169

(52) U.S. Cl. CPC G06F 16/215; G06F 16/285; G06F 40/169

(57) ABSTRACT

The present disclosure provides a method for deduplicating data using one or more machine learning models, such as a large language model (LLM). The method may comprise determining fields for deduplication based on a dataset schema. The method may involve generating groups of records from the dataset based on the determined fields. The method may include causing an LLM to annotate pairs of records from the groups to determine matching records. The method may comprise generating a classifier for detecting matching records based on the LLM and the annotated pairs. The method may involve determining groups of matching records based on the classifier. The method may include causing the LLM to merge the groups of matching records into one or more master records.

### CROSS-REFERENCE TO RELATED PATENT APPLICATION

This application claims priority to U.S. Prov. App. No. 63/655,228, filed on Jun. 3, 2024, the entirety of which is incorporated by reference herein.

### BACKGROUND

Tabular data, such as tables or spreadsheets, often contains duplicate records. These duplicates may arise from data integration pipelines that utilize multiple data sources with overlapping information. Deduplication, the process of identifying and removing these duplicates, typically relies on manually-defined rules, requires domain expertise, and and/or is often tedious. Some existing methods employ machine learning techniques to improve the process; however, this still necessitates human intervention for at least some steps in the deduplication pipeline. These and other considerations are described herein.

### SUMMARY

It is to be understood that both the following general description and the following detailed description are exemplary and explanatory only and are not restrictive. The methods, systems, and apparatuses described herein relate to improved deduplication pipelines. These deduplication pipelines may utilize one or more machine learning models, such as Large Language Models (LLMs), to (fully or partially) automate the process of identifying and removing duplicate records from tabular data.

The system may analyze a schema of a dataset to recommend fields that are most relevant for deduplication purposes. The system may then group similar records to reduce computational complexity. The LLM may annotate pairs of records to determine if they represent the same entity. A classifier, which may be associated with and/or comprise the LLM, may be trained based on these annotations to detect matching records. The system may aggregate matching pairs to form groups of records that refer to the same entity. The LLM may merge these records into a single authoritative record, often referred to as a “golden record” or a “master record”-both of which are used interchangeably herein.

The system may operate in either a fully automated mode or a semi-automated mode. The fully automated mode may minimize human intervention by allowing the LLM to execute all deduplication stages autonomously. The semi-automated mode may provide a hybrid approach in which users may manually validate and adjust LLM-selected fields and/or may contribute input during the record pair annotation stage.

The system may be integrated into traditional Extract, Transform, Load (ETL) processes. This integration may enhance data quality during the warehousing phase. The system may reduce the reliance on manually-defined rules and domain expertise. The system may improve the efficiency and accuracy of the deduplication process. The system may be particularly beneficial in environments where data is continuously ingested from multiple sources. The system may handle various types of data sources, including structured data like databases and spreadsheets, semi-structured data like XML or JSON files, and unstructured data like text documents or PDFs.

Other examples and configurations are possible as well. This summary is not intended to identify critical or essential features of the disclosure, but merely to summarize certain features and variations thereof. Other details and features will be described in the sections that follow.

### BRIEF DESCRIPTION OF DRAWINGS

The accompanying drawings, which are incorporated in and constitute a part of this specification, together with the description, serve to explain the principles of the present methods and systems:

FIG. 1A shows an example system, according to aspects of the present disclosure;

FIG. 1B shows an example system, according to aspects of the present disclosure;

FIG. 2 shows an example flowchart of an example automated deduplication process, according to aspects of the present disclosure;

FIG. 3A shows an example flowchart of a semi-automated deduplication process, according to aspects of the present disclosure;

FIGS. 3B-3K shows examples of a user interface for a semi-automated deduplication process, according to aspects of the present disclosure;

FIG. 4 shows an example system, according to aspects of the present disclosure; and

FIG. 5 shows a flowchart for an example method, according to the aspects of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The following detailed description provides an overview of various examples of systems and methods for automating the deduplication of tabular data. The disclosed methods and systems introduce an innovative approach to deduplicating tabular data by utilizing Large Language Models (LLMs) to automate the deduplication process, which traditionally requires substantial manual intervention. The automation encompasses several stages, including interpreting the data schema to recommend fields for deduplication, generating record groups, constructing and annotating record pairs to ascertain if they represent the same entity, and merging these records into a single authoritative record, referred to as the master record or the golden record.

The semi-automated deduplication process provides a hybrid approach, allowing user interaction at key stages to ensure a balance between automation and human expertise. Users have the option to manually validate and adjust the LLM-selected fields, contribute input or corrections during the record pair annotation stage, and supervise the merging of duplicate records into one or more master records. This process offers a collaborative environment where the LLM's automation is complemented by the user's domain knowledge and decision-making capabilities. By contrast, the fully automated deduplication process is designed to minimize human intervention, thereby increasing efficiency. It entrusts the LLM with the responsibility of executing all deduplication stages autonomously, from the initial field selection to the final merging of records. This process uses the LLM's capabilities to streamline the deduplication pipeline. Both the semi-automated and fully automated processes aim to enhance the deduplication pipeline by reducing the reliance on human intervention, thereby improving the accuracy and reliability of data deduplication. The semi-automated process allows for human oversight and input at various stages, while the fully automated process relies entirely on the LLM's judgment, offering solutions tailored to different operational requirements and preferences.

In some aspects, the disclosed methods and systems may be integrated into a traditional Extract, Transform, Load (ETL) process, which is commonly used to aggregate data from various sources, transform it into a consistent format, and load it into a data store or other repository. The ETL process typically includes a deduplication step to ensure the quality and uniqueness of the data being stored. By incorporating the disclosed deduplication methods and systems into the ETL process, organizations may benefit from a reduction in manual effort and an increase in the accuracy of their data repositories. The LLM's ability to learn and adapt to different data schemas and domains may further enhance the ETL process by providing a more dynamic and responsive deduplication step that is capable of handling a wide variety of data sources and formats. This integration may be particularly beneficial in environments where data is continuously being ingested from multiple sources, requiring ongoing deduplication efforts.

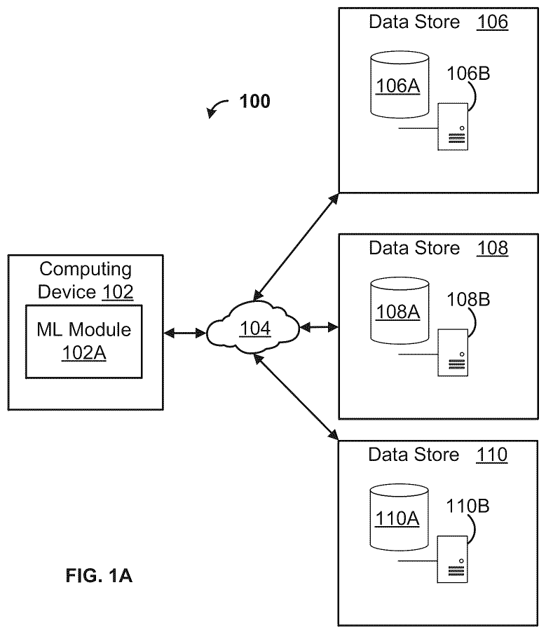

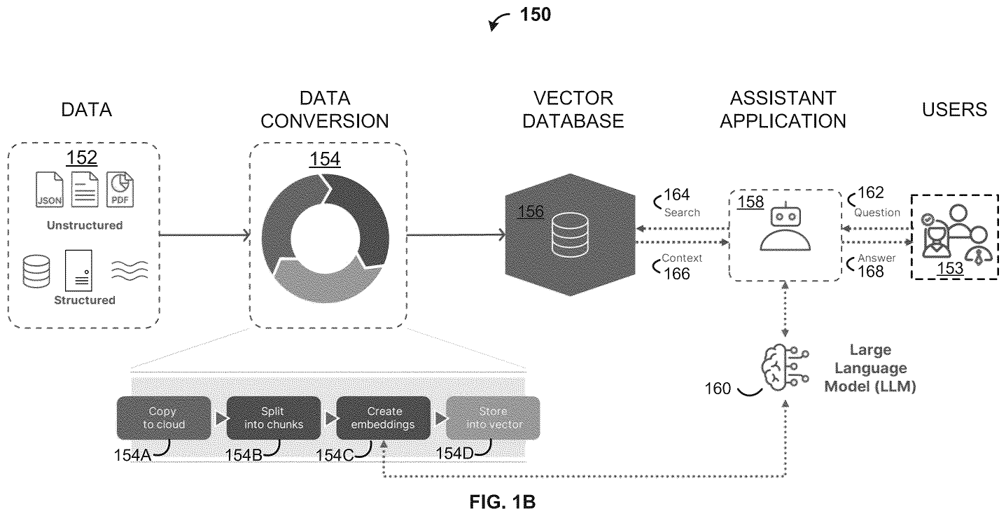

Turning now to FIG. 1A, a block diagram of an example system 100 is shown. The system 100 may comprise a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as one or more neural networks, Large Language Models (LLMs), segmentation models, ensemble models, a combination thereof, and/or the like. Though the ML module 102A is shown in FIG. 1A as being resident at the computing device 102, it is to be understood that the ML module 102A may be resident at one or more computing devices that may be local or remote to the computing device 102. Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

The ML module 102A may be a software component on the computing device 102. The ML module 102A may include, or be in communication with, one or more machine learning models, such as large language models (LLMs), that are trained to perform various tasks related to data deduplication. For example, the ML module 102A may send requests to the servers 106B, 108B, 110B to retrieve data from the data stores 106, 108, 110. The servers 106B, 108B, 110B may respond to these requests by sending the requested data back to the ML module 102A over the network 104. In some aspects, the ML module 102A may use the retrieved data to perform deduplication tasks. For example, the ML module 102A may analyze the schema of the data, recommend fields for deduplication, group similar records, construct pairs of records, annotate the pairs to identify duplicates, and merge duplicate records into a single master record. The ML module 102A may perform these tasks automatically, without requiring human intervention. In some cases, the ML module 102A may interact with a user interface to allow a user to manually select fields for deduplication, annotate pairs of records, or merge duplicate records.

In some aspects, the system 100 may be adapted to process various types of data sources. For instance, the system 100 may be configured to handle structured data sources. These structured data sources may include databases or spreadsheets, which typically organize data in a structured manner, such as in rows and columns. The computing device 102 may access these structured data sources via the network 104, and the ML module 102A may process the structured data.

In some cases, the system 100 may be adapted to process semi-structured and/or unstructured data sources. Semi-structured data sources may include XML or JSON files, which provide some level of data organization through tags and attributes, but do not conform to the rigid structure of databases or spreadsheets, while unstructured data may comprise file-based sources, such as presentations, mail archives, text documents, PDFs, transcripts, etc. The computing device 102 may access such data sources via the network 104.

In other cases, the system 100 may be adapted to process real-time data streams or data feeds. Real-time data streams or data feeds may include data that is continuously generated and transmitted, such as sensor data, social media feeds, financial market data, etc. The computing device 102 may access these real-time data streams or data feeds via the network 104, and the ML module 102A may process the real-time data. In each of these cases, and as further described herein, the data from the various data sources may be transformed into a format that may be consumed by an LLM.

FIG. 1B shows an example system 150. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For case of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 (e.g., a NL query) to the assistant application 158. The assistant application 158 may perform a search 162 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

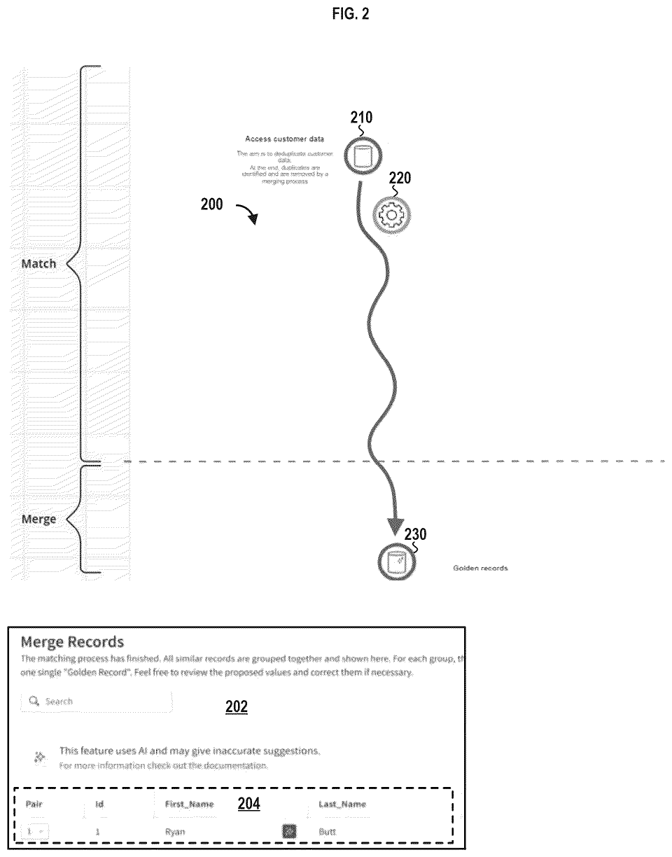

Turning now to FIG. 2, the figure illustrates a flowchart of the automated deduplication process 200, which streamlines the identification and merging of duplicate records in tabular data. This process uses the capabilities of an LLM to autonomously execute tasks from field selection to the creation of a consolidated master record 204. The process 200 may begin with accessing a dataset at step 210. In some examples, the dataset is accessed at step 210 in response to a user 153 submitting an NL request (e.g., a question 162) related to deduplication of one or more records. The NL request may indicate the dataset to be retrieved and/or the information about potentially duplicate records to be merged, such as one or more fields, column names, data values, data types, entity names, personal names, a combination thereof, and/or the like. The dataset may be stored within the first data store 106 and may be accessed by the computing device 102 via the network 104, for example. The dataset may be a tabular dataset, such as a spreadsheet or a database table, and may contain records of entities. Each record may represent an entity and may include multiple fields, each field representing a different attribute of the entity.

At step 220, the process 200 may involve field selection. The ML module 102A of the computing device 102 may analyze at least the schema of the dataset, which may include the names and types of the fields in the dataset. The ML module 102A may send a prompt to an LLM, asking the LLM to recommend fields that may be relevant for a deduplication process and/or an entity matching task. For example, the LLM may be prompted with a textual description of the records to be merged. The LLM may respond with recommended fields, which may be used for comparing records in subsequent steps of the process 200.

Following field selection, the process 200 may proceed to a blocking step (not shown). For example, a blocking algorithm may be used to group records based on the similarity of the selected fields. The blocking algorithm may be configured to reduce the complexity of constructing pairs of records in the next step of the process 200. The ML module 102A may assist in configuring the blocking algorithm based on the selected fields. The blocking algorithm serves as a preliminary step in the deduplication process and it may narrow down the number of record comparisons that the system will subsequently perform. In some aspects, the blocking algorithm may utilize various techniques such as sorting, hashing, or indexing to group records into blocks based on the similarity of the selected fields. By doing so, it ensures that records are compared within these blocks rather than against the whole dataset, which may be computationally intensive. In some cases, the blocking algorithm may apply a similarity threshold to the selected fields, so that records are grouped together if they meet or exceed this threshold. This threshold may be determined based on the characteristics of the data, such as the expected level of variation in the fields or the presence of common identifiers, etc.

Next, pairs of records may be constructed from each block of records. For example, a block of N records may yield a set of N×N pairs. Each pair may consist of two records from the same block. The process 200 may then proceed to pairs annotation where the ML module 102A may use the LLM to annotate a subset of the pairs from each block. The LLM may determine whether the two records in each pair refer to the same entity. The LLM may be prompted with a textual description of the two records, and may respond with a binary ‘yes’ or ‘no’ to indicate whether the records match, for example. Based on the annotated pairs, the LLM may be trained at the next step of the process 200. The LLM may be trained to detect matching records across the dataset. The LLM may be trained to function as, and/or be trained to use or to incorporate, a classifier for detecting matching records across the dataset. The LLM (and/or classifier) may be trained in this regard using a variety of machine learning techniques, such as a Random Forest algorithm. The training step may be automated using techniques like Automated Machine Learning (AutoML) techniques, for example. The trained LLM may be used to scale the deduplication process to larger datasets efficiently.

The trained LLM may be applied to all pairs of records to classify them as matches or non-matches. After classifying all the pairs of records, the process 200 may proceed to a matching pairs aggregation step. All pairs classified as matches may be aggregated to form groups of records that refer to the same entity. Subsequent to the classification of record pairs, the deduplication process 200 advances to step 230, which encompasses the consolidation of records. The ML module 102A may use the LLM to merge the records in each group into a single master record 204, shown in FIG. 2 within an interface 202. The LLM may be prompted with a description of all records to be merged, and may resolve conflicting values to produce the master record 204. The master record 204 may represent a unique entity and may contain the consolidated information from all the merged records. The master record 204 may be stored in the first data store 106 or another data store.

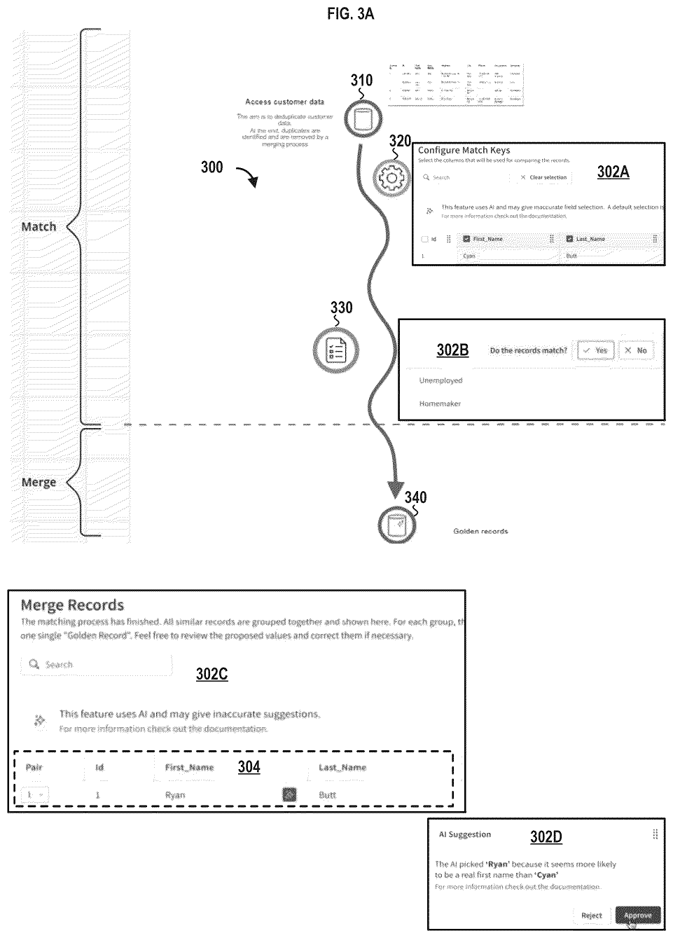

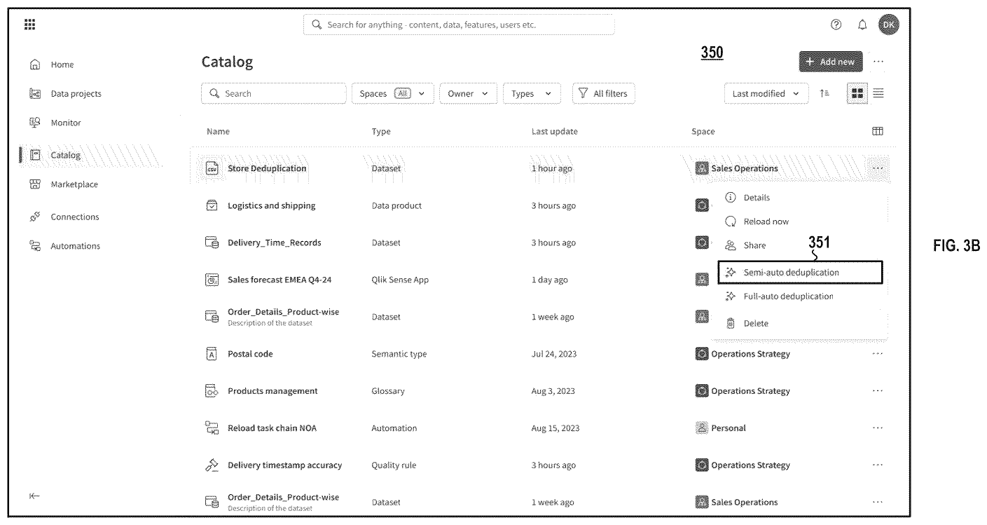

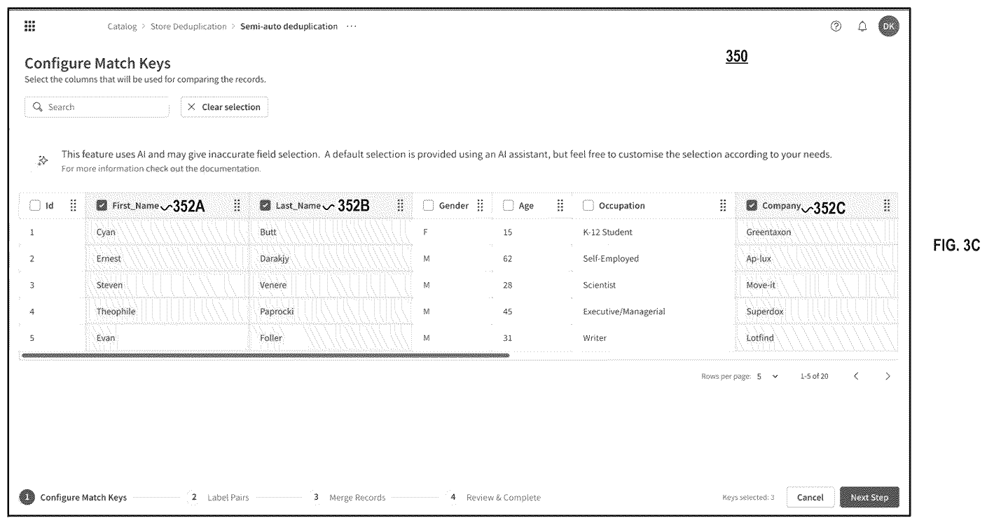

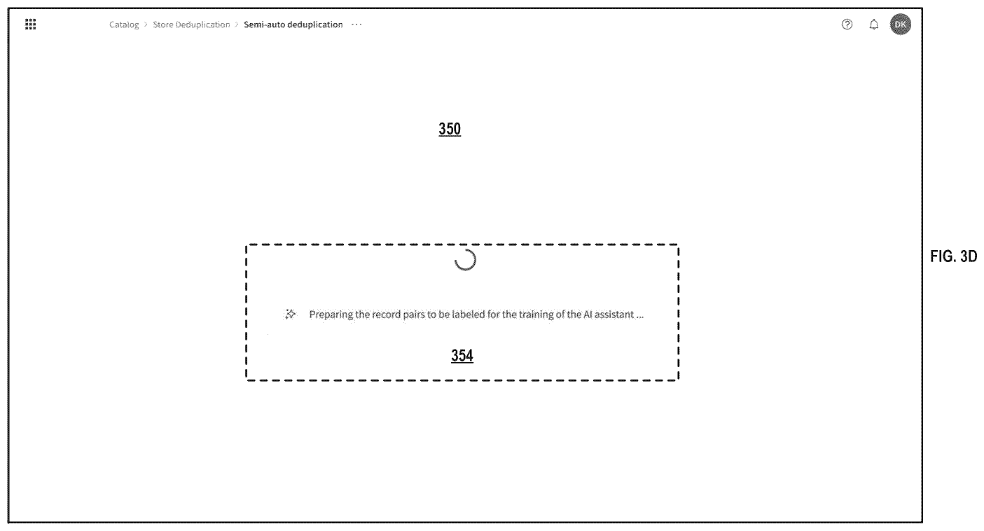

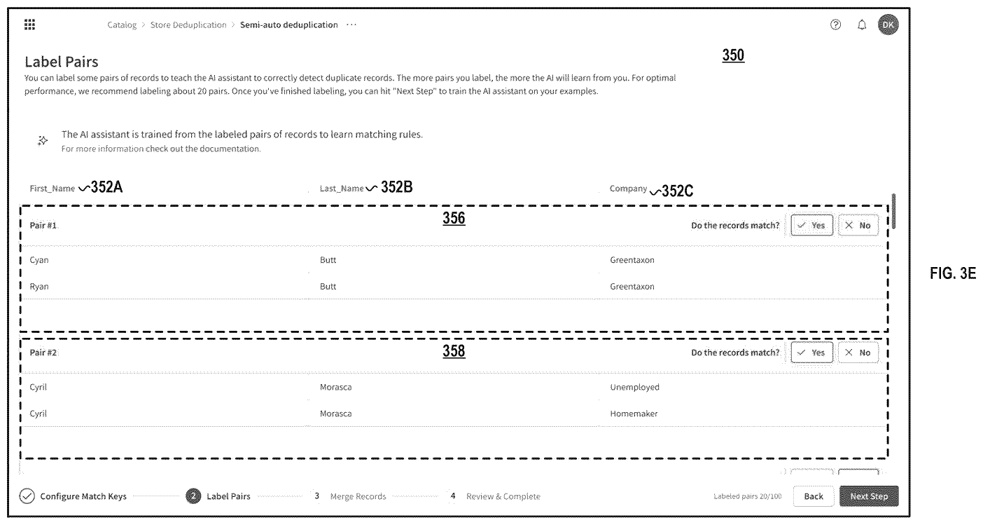

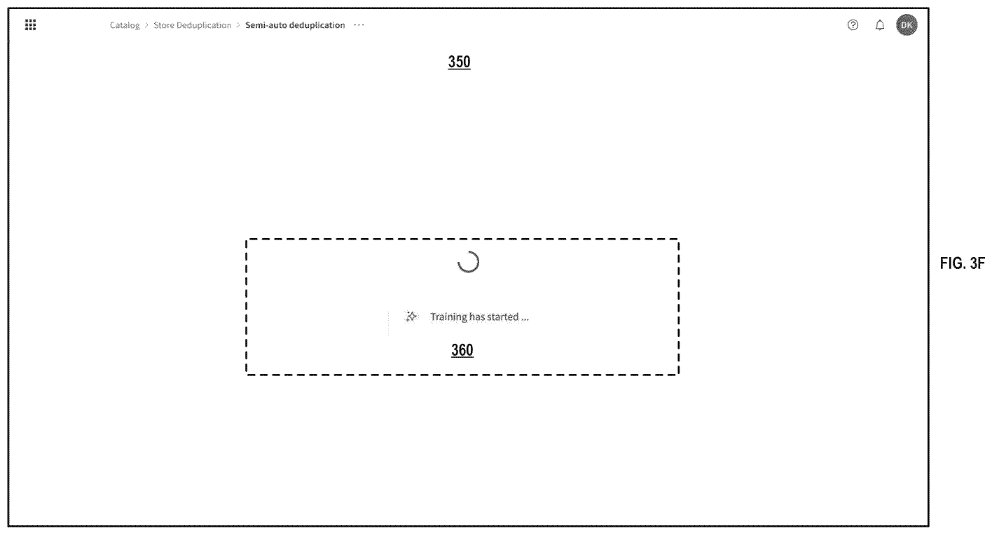

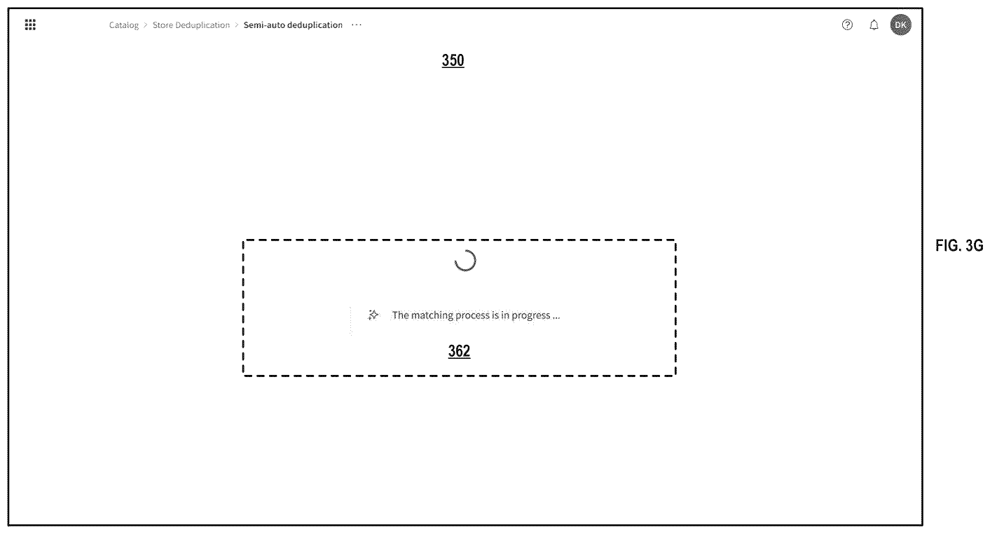

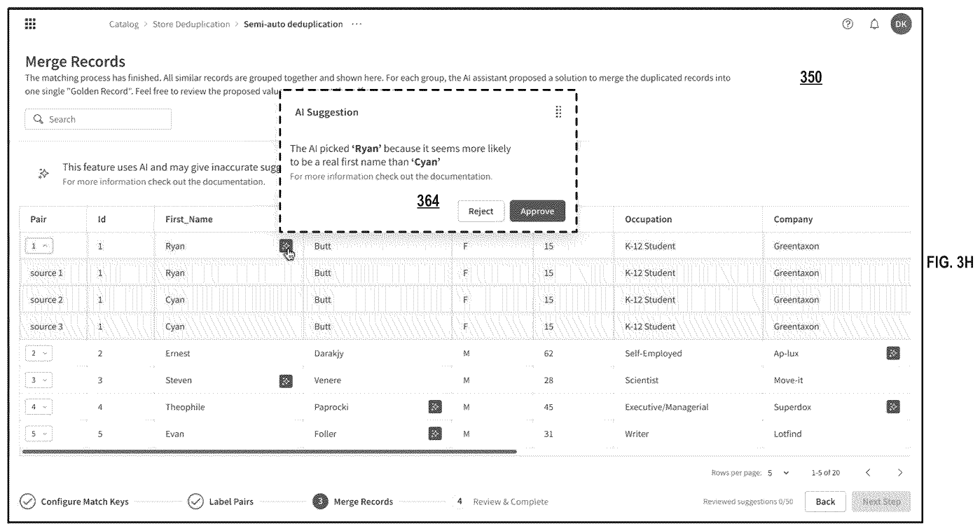

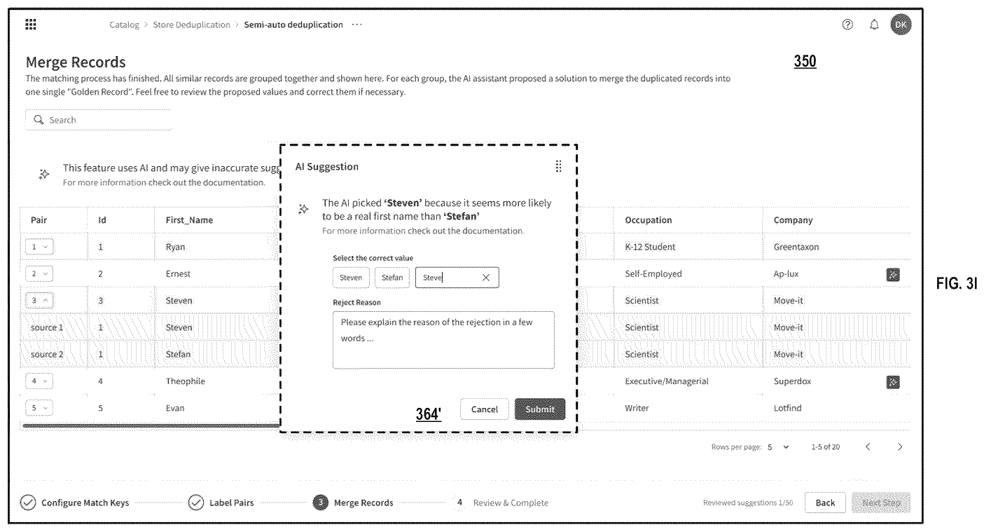

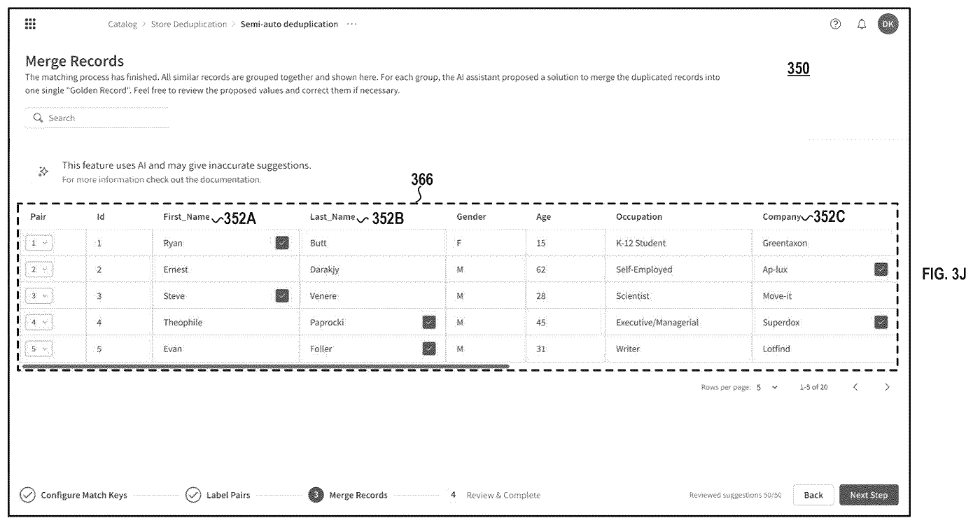

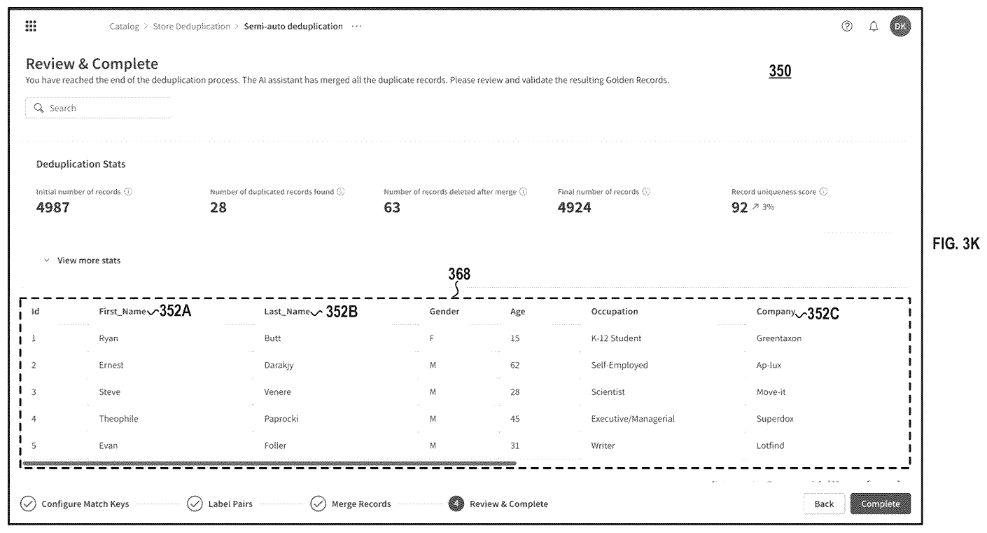

In some aspects, the deduplication process may be semi-automated, as depicted in FIG. 3A. The semi-automated deduplication process 300 may involve user interaction at various stages, providing a balance between automation and human expertise. This process may begin with accessing a dataset at step 310, similar to the automated process 200. That is, similar to the automated process 200, the dataset may be accessed at step 310 in response to a user 153 submitting an NL request (e.g., a question 162) related to deduplication of one or more records. The NL request may indicate the dataset to be retrieved and/or the information about potentially duplicate records to be merged such as one or more fields, column names, data values, data types, entity names, personal names, a combination thereof, and/or the like. The dataset may be stored within the second data store 108 and may be accessed by the computing device 102 via the network 104, for example.

At step 320, the process 300 may involve field selection. The ML module 102A of the computing device 102 may analyze at least the schema of the dataset and send a prompt to an LLM, asking the LLM to recommend fields that may be relevant for a deduplication process and/or an entity matching task (similar to step 220). The LLM may respond with recommended fields, which may be used for comparing records in subsequent steps of the process 300. In contrast to the automated process 200, a user may manually validate and adjust the LLM-selected fields via a user interface, such as a match keys configuration interface 302A. Following field selection, the process 300 may proceed to a blocking step (not shown), similar to the automated process 200. A blocking algorithm may be used to group records based on the similarity of the selected fields. The blocking algorithm may be configured to reduce the complexity of constructing pairs of records in the next step of the process 300. The ML module 102A may assist in configuring the blocking algorithm based on the selected fields.

Next, pairs of records may be constructed from each block of records. For example, a block of N records may yield a set of N×N pairs. Each pair may consist of two records from the same block. The process 300 may then proceed to pairs annotation at step 330, where a user of the computing device 102, for example, may annotate a subset of the pairs from each block. In contrast to the automated process 200, a user may interact during this step via an annotation interface 302B. Following manual annotation of the subset of the pairs, in some examples of the process 300, the LLM may be used to increase a size of the training set (e.g., when the subset of annotated pairs is small). For example, the manually-annotated pairs may be provided to the LLM as “few-shot” training examples, and the LLM may generate additional annotated pairs based on those few-shot training examples. Then, based on the annotated pairs, the LLM may be trained at the next step of the process 300. The LLM may be trained to detect matching records across the dataset. The LLM may be trained to function as, and/or be trained to use or to incorporate, a classifier for detecting matching records across the dataset. The LLM (and/or classifier) may be trained in this regard using a variety of machine learning techniques, such as a Random Forest algorithm. The training step may be automated using techniques like AutoML. The trained LLM may be used to scale the deduplication process to larger datasets efficiently.

The trained LLM may be applied to all pairs of records to classify them as matches or non-matches. After classifying all the pairs of records, the process 300 may proceed to a matching pairs aggregation step. All pairs classified as matches may be aggregated to form groups of records that refer to the same entity. Subsequent to the classification of record pairs, the deduplication process 300 advances to step 340, which encompasses the consolidation of records. The ML module 102A may use the LLM to merge the records in each group into a single master record 304, shown in FIG. 3A within an interface 302C. The LLM may be prompted with a description of all records to be merged, and may resolve conflicting values to produce the master record 304. In some examples, an interface 302D may present optional AI-generated suggestions for elements of one or more merged records. The master record 304 may represent a unique entity and may contain the consolidated information from all the merged records. The master record 304 may be stored in the second data store 108 or another data store.

In contrast to the automated process 200, a user may supervise the merging of records via the merge records interface 302C, providing feedback to the LLM to improve the accuracy of the master record 304. In some cases, the semi-automated deduplication process 300 may provide a more flexible and customizable approach to data deduplication. By allowing user interaction at certain steps/stages, the process 300 may accommodate the unique requirements and preferences of different users or organizations. For example, a user may prefer to manually validate the LLM-selected fields to ensure that they are relevant to the specific deduplication task at hand. Similarly, a user may wish to provide input during the pairs annotation and records merging stages to use their domain knowledge and improve the accuracy of the deduplication process.

As shown in FIG. 3B, the user interface (UI) 350 displays the entry point for the semi-automated deduplication process 300. The UI 350 presents a data catalog view with multiple data assets listed in a tabular format. Each row represents a distinct data asset with columns displaying attributes such as name, type, last update time, and the organizational space to which the asset belongs. The UI 350 includes filtering options at the top for spaces, owner, and types, along with a search bar to help users locate specific datasets. A context menu with a UI selection 351 is displayed, showing options including “Semi-auto deduplication” and “Full-auto deduplication,” allowing users to choose their preferred deduplication approach. This interface serves as the starting point for users to select datasets for the deduplication process 300.

FIG. 3C illustrates the match keys configuration interface corresponding to step 320 of the process 300. The UI 350 displays a data table with multiple columns including Id, First_Name, Last_Name, Gender, Age, Occupation, and Company. Three columns are pre-selected with checkmarks: First_Name (352A), Last_Name (352B), and Company (352C). These selections may represent the fields that the LLM has recommended as most relevant for the deduplication process (or they may be user-selected). FIG. 3D shows a loading screen that appears after the field selection step and before the pairs annotation step. The UI 350 displays a circular loading spinner accompanied by a notification 354 stating “Preparing the record pairs to be labeled for the training of the AI assistant . . . .” This loading screen indicates that the system/LLM is processing the selected fields and applying a blocking algorithm to group similar records and generate pairs for annotation, for example. This intermediate processing step may be performed to reduce the computational complexity of the deduplication task by limiting comparisons to records within the same block, for example.

FIG. 3E illustrates a pairs annotation interface corresponding to step 330 of the process 300. The UI 350 presents pairs of records for comparison, with fields for First_Name (352A), Last_Name (352B), and Company (352C). Two pairs are visible: a first training pair 356 showing “Cyan Butt” from “Greentaxon” compared with “Ryan Butt” from “Greentaxon,” and a second training pair 358 showing “Cyril Morasca” listed as “Unemployed” compared with another “Cyril Morasca” listed as “Homemaker.” For each pair, the interface provides “Yes” and “No” buttons, allowing users to indicate whether the records match. The interface also includes an informational note explaining that the AI assistant is trained from labeled pairs of records to learn matching rules. This interface enables users to manually annotate pairs of records, using their domain knowledge to identify true matches, which will subsequently be used to train the LLM and/or classifier as described herein.

FIG. 3F displays a loading screen that appears after the pairs annotation step and before the LLM training step. This loading screen indicates that the system is using the annotated pairs to train the LLM and/or classifier that will detect matching records across the dataset. The notification 360 provides feedback to the user about the current system state, informing them that the training process is underway. FIG. 3G shows another loading screen that appears after the LLM/classifier training step. The UI 350 displays a circular loading spinner accompanied by a notification 362 stating “The matching process is in progress . . . .” This loading screen indicates that the system is applying the trained LLM/classifier to all pairs of records to classify them as matches or non-matches. The notification 362 provides feedback to the user about the current system state, informing them that the matching process is underway.

FIG. 3H illustrates an AI suggestion interface that may correspond to the notification shown in FIG. 3A during the records merging step 340 of the process 300. The UI 350 displays an AI suggestion 364 popup window showing a specific case where the AI has selected one value over another. The suggestion provides a rationale for the selection, such as indicating that one name is more likely to be a real first name than another. The interface provides options for the user to accept or reject the suggestion. This interface enables users to review and validate AI-generated suggestions for resolving conflicting values when merging duplicate records, ensuring that the resulting master records are accurate and reliable.

FIG. 3I shows the merge records interface corresponding to step 340 of the process 300. The UI 350 displays a table with columns for Pair ID, First_Name, Last_Name, Gender, Age, Occupation, and Company. The interface shows groups of records that have been identified as potential duplicates. At the top of the screen, there's explanatory text stating that the matching process has finished and similar records are grouped together, with the AI assistant proposing solutions to merge duplicated records into a single master record. The interface includes an AI suggestion 364 popup showing that the system has selected “Ryan” over “Cyan” as it seems more likely to be a real first name. Another AI suggestion 364′ may appear for a different field or record. The interface provides “Reject” and “Approve” buttons for the user to validate these suggestions. This interface enables users to supervise the merging of duplicate records, providing feedback to the LLM to improve the accuracy of the resulting master records.

FIG. 3J illustrates another view of the merge records interface. The UI 350 displays a table with multiple columns including First_Name (352A), Last_Name (352B), Gender, Age, Occupation, and Company (352C). The interface shows final merged records 366 with green checkmarks indicating selected or validated values for each field. This interface may allow users to review the merged records before they are finalized as master records. Users can make adjustments to the merged records if necessary, ensuring that the resulting master records accurately represent the unique entities in the dataset.

FIG. 3K shows the final review and complete interface of the deduplication process 300. The UI 350 displays deduplication statistics at the top, showing an initial number of records, the number of duplicated records found, the number of records deleted after merge, and the final count of records, along with a record uniqueness score and percentage improvement. Below the statistics is a data table showing the final merged records 366 with columns for Id, First_Name (352A), Last_Name (352B), Gender, Age, Occupation, and Company (352C). At the bottom of the screen are four process steps indicated by checkmarks: “Configure Match Keys,” “Label Pairs,” “Merge Records,” and “Review & Complete” (currently active). The interface also includes “Back” and “Complete” buttons for navigation. This interface provides a comprehensive summary of the deduplication process, allowing users to review the results before finalizing the process.

The LLM(s) used in the deduplication processes described herein may be trained using various machine learning algorithms to accurately identify matching records within a dataset. For instance, in addition to the Random Forest algorithm mentioned, the LLM could be trained using a Support Vector Machine (SVM) algorithm. Another example of a LLM that could be employed is a Neural Network, particularly a deep learning model, which could learn complex patterns and relationships between fields in the records. This type might be particularly useful when dealing with large datasets with intricate patterns that simpler models might not capture effectively. A K-Nearest Neighbors (KNN) algorithm could also be used as a classifier in this context, such as to classify records based on a majority vote, etc., with records being assigned to the class that is the common class among their nearest neighbors. Additionally, a Naive Bayes classifier could be utilized, particularly if the dimensionality of the input is high. In other cases, an ensemble method, such as Gradient Boosting or AdaBoost, could be used to combine the predictions from multiple classifiers to improve the robustness and accuracy of the deduplication process.

For each of these, the training process may involve feeding annotated pairs of records as input, where the features are derived from the fields of the records and the target variable (for the classification process) may indicate whether the pair of records match or not. The model then learns to predict the target variable for new, unseen pairs of records, facilitating the deduplication of the dataset. The choice of model may depend on factors such as the size of the dataset, the complexity of the relationships between fields, the computational resources available, and the desired accuracy of the deduplication process.

In some aspects, the system 100 may use different prompts for the LLM(s) at each of the steps in the deduplication processes described herein, namely field selection, pairs annotation, and records merging. Each prompt may be composed of an instruction and a set of inputs. For field selection, the prompt may ask the LLM to select the columns of the table that are the most relevant for comparing records to each other in the context of a deduplication process. As inputs, the ML module 102A may provide the schema of the table. For pairs annotation, the prompt may ask the LLM to answer whether or not two records from a table correspond to the same entity and thus, whether they may be considered as duplicates. The expected answers may be yes or no. As inputs, the ML module 102A may provide a textual description of the two records, including their columns names and attribute values. For records merging, the prompt may ask the LLM to merge the presented records into one by resolving the conflicting values of some attributes. As inputs, the ML module 102A may provide the textual description of all the records to be merged, including their columns names and attribute values. It is to be noted that the exact formulation of the prompt may not be fixed in this system 100 as it might vary from one LLM to another to maximize performance.

The present methods and systems may improve data governance in a wide-array of fields. Consider a healthcare provider that manages patient records across multiple clinics, each using different data management systems. Over time, patient records have been duplicated due to patients visiting multiple clinics and administrative errors, for example. The provider may seek to consolidate these records to improve patient care and operational efficiency. For example, utilizing the automated deduplication process 200, the healthcare provider begins by accessing their dataset, which may be stored at the first data store 106. The computing device 102, through the network 104, may retrieve patient records that may contain fields such as patient ID, name, date of birth, and treatment history.

The ML module 102A may then analyze at least the schema of the dataset and prompt an LLM to recommend fields for deduplication. The LLM suggests fields such as patient ID and name, which are then used to compare records. The process then employs a blocking algorithm to group similar records, reducing the number of comparisons. For instance, records may be grouped by birth month or the first three letters of a last name. Pairs of records are constructed within each block, and the ML module 102A uses the LLM to annotate pairs, determining if they refer to the same patient. The LLM's response guides the training to detect matching records, automating the process and scaling it to handle the extensive dataset efficiently.

After the LLM is trained, it classifies all pairs of records as matches or non-matches. Matched pairs are aggregated to form groups of records that refer to the same patient. Finally, the ML module 102A merges the records in each group into a single master record. The LLM resolves conflicting values, such as different addresses or misspelled names, to create a comprehensive and accurate master record for each patient. The master record, now a unique and consolidated patient profile, is stored back in the first data store 106.

Additionally, the semi-automated deduplication process may improve data governance in a wide-array of fields. For instance, large institutions often deal with large volumes of customer data that include account information, transaction histories, and personal identification details. Over time, due to various factors such as data entry errors, system migrations, or customer updates, duplicate records of the same customer may exist across different databases or within the same database. This redundancy not only occupies unnecessary storage space but also poses challenges in maintaining data accuracy and providing consistent customer service.

By implementing the semi-automated deduplication process, a large institution could streamline its customer data management. The process would begin with the large institution accessing its customer datasets, which may be stored across multiple data stores. The ML module would analyze at least the schema of the datasets and, with the assistance of an LLM, recommend fields such as account numbers, customer names, and social security numbers, as examples, that are pertinent for deduplication. A user, such as a data analyst, could then validate and adjust the LLM-selected fields to ensure they align with data governance policies, for example. The blocking algorithm would group similar records, and the data analyst could use the annotation interface to manually review and annotate pairs of records, using their expertise to identify true matches. The trained LLM would then automate the classification of pairs across the dataset. Finally, the ML module would merge the records in each group into a single master record, with the data analyst supervising the merging process through the merge records interface. This would result in a consolidated and accurate customer profile.

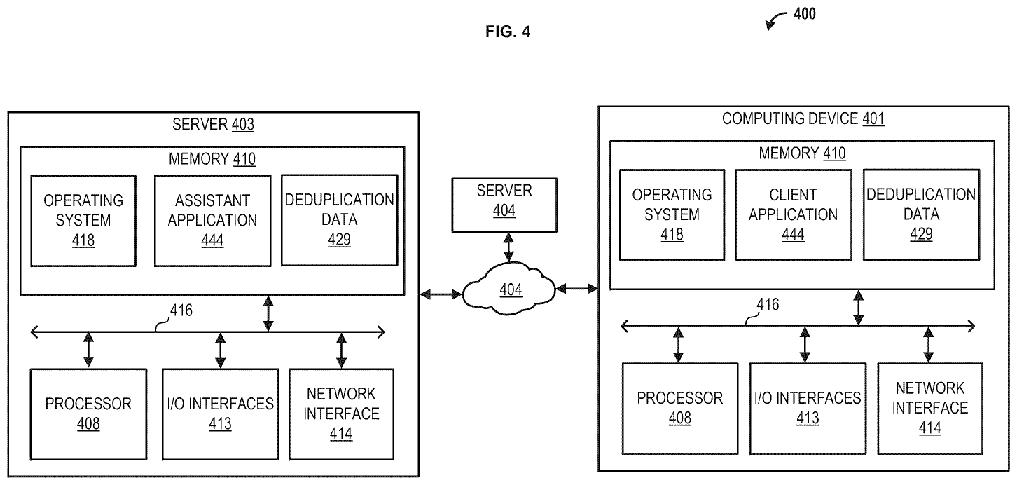

The present methods and systems may be computer-implemented. FIG. 4 shows a block diagram depicting a system/environment 400 comprising non-limiting examples of a computing device 401 and a server 402 connected through a network 404. Either of the computing device 401 or the server 402 may be a computing device, such as any of the devices of the system 100 shown in FIG. 1A and/or any of the devices of the system 150 shown in FIG. 1B. In an aspect, some or all steps of any described method may be performed on a computing device as described herein. The computing device 401 may comprise one or multiple computers configured to store deduplication data 429, and/or the like. The server 402 may comprise one or multiple computers configured to store deduplication data 429 (e.g., tabular data, spreadsheet data, table data, etc.). Multiple servers 402 may communicate with the computing device 401 via the through the network 404.

The computing device 401 and the server 402 may be a digital computer that, in terms of hardware architecture, generally includes a processor 408, system memory 410, input/output (I/O) interfaces 412, and network interfaces 414. These components (408, 410, 412, and 414) are communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 may execute software stored within the system memory 410, to communicate data to and from the system memory 410, and to generally control operations of the computing device 401 and the server 402 pursuant to the software.

The I/O interfaces 412 may be used to receive user input from, and/or for providing system output to, one or more devices or components. User input may be provided via, for example, a keyboard and/or a mouse. System output may be provided via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the server 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise the deduplication data 429, the application data 424, and a suitable operating system (O/S) 418. In the example of FIG. 4, the software in the system memory 410 of the server 402 may comprise the deduplication data 429, the application data 424, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are shown herein as discrete blocks, although it is recognized that such programs and components may reside at various times in different storage components of the computing device 401 and/or the server 402. An implementation of the system/environment 400 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

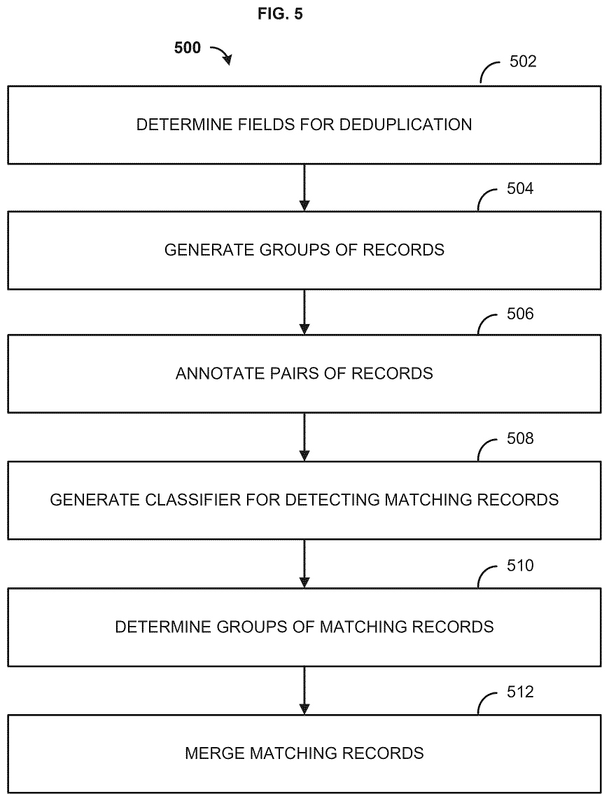

FIG. 5 shows a flowchart of an example method 500. The method 500 may be performed in whole or in part by a single computing device, a plurality of computing devices, and the like. For example, the steps of the method 500 may be performed by the computing device 102. Some steps of the method 500 may be performed by a first computing device (e.g., the content server 108), while other steps of the method 600 may be performed by another computing device. The method 500 begins at step 502, where fields for deduplication are determined based on a schema of a dataset. This step may involve analyzing the structure and organization of the dataset to identify fields that are most relevant for the deduplication process. For example, the ML module 102A may analyze at least the schema of the dataset and send a prompt to an LLM, requesting recommendations for fields that would be effective for entity matching. The LLM may then respond with a set of recommended fields based on its analysis of the schema. In a semi-automated implementation similar to the process 300 shown in FIG. 3A, a user may validate these recommendations through a match keys configuration interface 302A, where they can manually adjust the field selection as needed.

At step 504, the method 500 proceeds to generate groups of records from the dataset based on the determined fields. This step may implement a blocking algorithm to group similar records together, thereby reducing the computational complexity of subsequent comparison operations. The blocking algorithm may analyze the values in the selected fields and group records that share similar characteristics. This approach is analogous to the grouping process that occurs after field selection in the semi-automated process 300 depicted in FIG. 3A, where records with similar attributes are grouped together before proceeding to the annotation phase.

The method 500 continues to step 506, where pairs of records are annotated. For example, a large language model (LLM) may be utilized to annotate pairs of records from the generated groups to determine matching records. In this step, the LLM (e.g., via the ML module 102A) may construct pairs of records from each block and prompt the LLM to determine whether each pair represents the same entity. The LLM may analyze the textual description of the records, including their field names and values, and provides a binary response indicating whether the records match. This annotation process is similar to step 330 in the semi-automated process 300 shown in FIG. 3A, where pairs of records are presented for annotation. In the semi-automated approach, this annotation may be performed through an annotation interface 302B as illustrated in FIG. 3E, where training pairs such as the first training pair 356 and second training pair 358 are presented for user evaluation.

At step 508, the method 500 involves generating (or selecting) a classifier (e.g., LLM, ML model(s), etc.) for detecting matching records based on the annotated pairs. In some examples, the LLM comprises the classifier, and generating the classifier may include selecting the LLM as the classifier. The annotated pairs from step 506 serve as training data for the LLM and/or classifier to identify matching records across the entire dataset. The training process may be automated using techniques like AutoML, for example. This step corresponds to the training phase that would occur after the annotation step 330 in the semi-automated process 300, where a notification 360 indicating “Training has started . . . ” might be displayed to the user as shown in FIG. 3F.

The method 500 proceeds to step 510, where groups of matching records are determined. For example, the groups of matching records may be determined via the LLM and/or the classifier. In this step, the trained LLM and/or classifier is applied to all pairs of records within each block to classify them as matches or non-matches. The pairs classified as matches are then aggregated to form groups of records that refer to the same entity. This step is analogous to the matching process that would follow the training phase in the semi-automated process 300, where a notification 362 indicating “The matching process is in progress . . . ” might be displayed as shown in FIG. 3G.

Finally, at step 512, the method 500 concludes with merging matching records. For example, the LLM and/or classifier may merge the groups of matching records into one or more master records. The LLM and/or classifier may be prompted with descriptions of all records within each matching group and tasked with resolving any conflicting values to produce a single, consolidated master record for each entity. This step corresponds to step 340 in the semi-automated process 300 shown in FIG. 3A, where records are merged into master records 304. In a semi-automated implementation, this merging process might involve user interaction through a merge records interface 302C as shown in FIG. 3I, where AI suggestions 364 and 364′ might be presented to assist in resolving conflicts between record values. The final merged records 366, as shown in FIG. 3J and FIG. 3K, represent the master records that result from this merging process.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, based on a schema of a dataset, one or more fields for deduplication;
generating, based on the one or more fields, groups of records from the dataset;
causing a large language model (LLM) to annotate pairs of records from the groups to determine matching records;
generating, based on the LLM and the annotated pairs, a classifier for detecting matching records;
determining, based on the classifier, groups of matching records; and
causing the LLM to merge the groups of matching records into one or more master records.

2. The method of claim 1, wherein determining the one or more fields for deduplication comprises:
causing the LLM to analyze at least the schema of the dataset; and
receiving, from the large language model, a recommendation of the one or more fields.

3. The method of claim 2, further comprising receiving, via a user interface, a validation of the recommended one or more fields.

4. The method of claim 1, wherein generating the groups of records comprises applying a blocking algorithm to group records based on similarity of values in the one or more fields.

5. The method of claim 1, wherein generating the classifier comprises training, based on the annotated pairs of records, a machine learning model, wherein the machine learning model comprises the LLM.

6. The method of claim 1, wherein the LLM comprises the classifier.

7. The method of claim 1, further comprising storing the one or more master records in a data store.

8. An apparatus comprising:
at least one processor; and
memory storing processor-executable instructions that, when executed by the at least one processor, cause the apparatus to:
receive a dataset for deduplication;
determine, via a large language model (LLM), fields in the dataset relevant for deduplication;
generate groups of records based on the determined fields;
cause the LLM to annotate pairs of records to identify matches;
train a classifier using the annotated pairs;
apply the classifier to the dataset to identify groups of matching records; and
generate one or more master records by merging the groups of matching records using the LLM.

9. The apparatus of claim 8, wherein the processor-executable instructions that cause the apparatus to determine the fields in the dataset relevant for deduplication further cause the apparatus to:
prompt the LLM with at least a schema of the dataset; and
receive, from the LLM, a recommendation of fields relevant for deduplication.

10. The apparatus of claim 9, wherein the processor-executable instructions further cause the apparatus to receive, via a user interface, a validation of the recommended fields.

11. The apparatus of claim 8, wherein the processor-executable instructions that cause the apparatus to generate groups of records further cause the apparatus to apply a blocking algorithm to group records based on similarity of values in the determined fields.

12. The apparatus of claim 8, wherein the processor-executable instructions that cause the apparatus to train the classifier further cause the apparatus to train, based on the annotated pairs of records, a machine learning model.

13. The apparatus of claim 12, wherein the machine learning model comprises the LLM.

14. The apparatus of claim 8, wherein the LLM comprises the classifier.

15. A non-transitory computer-readable medium storing processor-executable instructions that, when executed by at least one processor, cause the at least one processor to:
receive a dataset for deduplication;
determine, via a large language model (LLM), fields in the dataset relevant for deduplication;
generate groups of records based on the determined fields;
cause the LLM to annotate pairs of records to identify matches;
train a classifier using the annotated pairs;
apply the classifier to the dataset to identify groups of matching records; and
generate one or more master records by merging the groups of matching records using the LLM.

16. The non-transitory computer-readable medium of claim 15, wherein the processor-executable instructions that cause the at least one processor to determine the fields in the dataset relevant for deduplication further cause the at least one processor to:
prompt the LLM with at least a schema of the dataset; and
receive, from the LLM, a recommendation of fields relevant for deduplication.

17. The non-transitory computer-readable medium of claim 16, wherein the processor-executable instructions further cause the at least one processor to receive, via a user interface, a validation of the recommended fields.

18. The non-transitory computer-readable medium of claim 15, wherein the processor-executable instructions that cause the at least one processor to generate groups of records further cause the at least one processor to apply a blocking algorithm to group records based on similarity of values in the determined fields.

19. The non-transitory computer-readable medium of claim 15, wherein the processor-executable instructions that cause the at least one processor to train the classifier further cause the at least one processor to train, based on the annotated pairs of records, a machine learning model, wherein the machine learning model comprises the LLM.

20. The non-transitory computer-readable medium of claim 15, wherein the LLM comprises the classifier.
